(19) United States
(12) Patent Application Publication
(10) Pub. No.: US 2015/0068374 A1
(43) Pub. Date: Mar. 12, 2015

(54) GUIDING INSTRUMENT FOR A CUTTING TOOL

(71) Applicant: Wayne Roth, Stryker, OH (US)

(72) Inventor: Wayne Roth, Stryker, OH (US)

(21) Appl. No.: 14/479,784

(22) Filed: Sep. 8, 2014

Related U.S. Application Data
(60) Provisional application No. 61/874,412, filed on Sep. 6, 2013.

(51) Int. Cl. B26B 29/06; G01B 3/04

(52) U.S. Cl. CPC B26B 29/06; G01B 3/04
USPC 83/13; 33/456

(57) ABSTRACT

A guiding instrument for forming a cut in a work piece with a cutting tool includes a base member, a guide member, and an elongated linking member. The base member has an aligning wall and a platform. The aligning wall is configured for alignment with an edge of the work piece. The platform extends outwardly from the aligning wall. The guide member is pivotally coupled to the base member. The elongated linking member extends between the base member and the guide member. The first end of the elongated linking member is coupled to the base member and the second end of the elongated linking member is releasably coupled to at least one of base member and the guide member.

This application claims priority to U.S. Provisional Patent Application Ser. No. 61/874,412 filed Sep. 6, 2013, hereby incorporated herein by reference in its entirety.

### FIELD OF THE INVENTION

The present disclosure relates to a guiding instrument for a cutting tool, more particularly, to a portable guiding instrument for a cutting tool that provides precise measurements for use in duct installation applications.

### BACKGROUND OF THE INVENTION

Cutting tools are used to cut duct board panels to fabricate ducting systems for heating, ventilation, and air conditioning (HVAC) installations. Typically, knives and other cutting tools are used to create a cut or groove through a duct board panel. The cuts and grooves facilitate forming a section of an insulation layer for ducting systems by bending the duct board panel along the cuts and grooves.

In certain applications, a “V” groove is formed into the duct board panels by cutting tools. Typically, three V grooves are cut lengthwise into the duct board panel at pre-selected locations. The duct board panel is then folded about itself at the V grooves to create a substantially rectangular duct. The V grooves are formed by a knife attached to a hand held tool such as a hand held sled, for example, FASGROOV™ brand hand held sleds available from Malco Products, Inc.

Portable instruments used to facilitate guiding a cutting tool to form cuts or grooves in the duct board panels are known. For example, in U.S. Pat. No. 5,040,297, an adjustable square is described. The adjustable square guides a panel cutter and includes an angle arm, a protractor, and channel arm. The square guides the cutting tool to cut the grooves in the panel across the length of the panel.

Additionally, in U.S. Pat. No. 4,608,902, a measuring and guiding device is described. The device has no moving parts and may be guided by a user along the length of a fiber glass duct board. The frame includes a base leg being of channel form and having measuring line markings. The base leg has a depth equal to the depth of a conventional fiber glass panel and is configured to align with a longitudinal edge of the fiber glass panel. A guide leg overlies the fiber glass panel in a perpendicular relationship to the length of the base leg. The guide leg guides a cutting tool along the edge thereof to create V grooves in the panel. A hypotenuse leg of the frame includes indicia that corresponds and aligns with the indicia of the base leg.

Precision in measuring and cutting the V grooves is often required for forming ducts from the duct board panels. If the measurements are not precise, the form of the duct can be skewed. The guiding instruments known in the art have base legs having a side configured to contact the edge of the duct panel. However, duct board panels are often formed with male and female ship lapped ends to facilitate fitting each section of duct to another section of duct. Measurement precision may be reduced when the base leg is in contact with a female ship lapped end because the surface of base leg is at a distance from the cutting surface of the duct panel.

Additionally, the portable instruments known in the art can easily bend or flex upon applying pressure to the instrument while cutting the duct panels. The bending and flexing can also contribute to inaccurate or uneven cuts. Furthermore, the instruments known in the art neither provide sturdy means for cutting angles in the duct board panels nor provide interchangeability for both left-hand cuts and right-hand cuts. Angles formed in the duct board panels facilitate increasing or decreasing the cross section of the duct or for use when forming both left-hand cuts and right-hand cuts.

There is a continuing need for a sturdy guiding instrument for a cutting tool that is portable, uncomplicated to use, facilitates precision and accuracy in cutting, and is easy to manufacture. Therefore, it would be advantageous if a guiding instrument for a cutting tool could be improved.

### SUMMARY OF THE INVENTION

In accordance and attuned with the instant disclosure, a sturdy guiding instrument for a cutting tool that is portable, uncomplicated to use, facilitates precision and accuracy in cutting, and is easy to manufacture has surprisingly been discovered.

According to one embodiment of the disclosure, a guiding instrument for forming a cut in a work piece with a cutting tool is disclosed. The guiding instrument includes a base member having an aligning wall and a platform. The aligning wall is configured for alignment with an edge of the work piece. The platform extends outwardly from the aligning wall. The guiding instrument further includes a guide member pivotally coupled to the base member and an elongated linking member extending between the base member and the guide member. A first end of the elongated linking member is coupled to the base member and the second end of the elongated linking member is releasably coupled to at least one of the base member and the guide member.

According to another embodiment of the disclosure, a guiding instrument for forming a cut in a work piece with a cutting tool is disclosed. The guiding instrument includes a base member having an aligning wall and a platform. The aligning wall is configured for alignment with an edge of the work piece. The platform extends outwardly from the aligning wall. The guiding instrument further includes a guide member pivotally coupled to the base member and an elongated linking member extendable between the base member and the guide member. A first end of the elongated linking member is coupled to the base member and the second end of the elongated linking member is releasably coupled to at least one of the base member and the guide member. The base member, the guide member, and the elongated linking member cooperate to selectively form at least a first arrangement, a second arrangement, and a third arrangement.

According to a further embodiment of the disclosure, a method of forming a cut in a work piece is disclosed. The method includes the steps of providing a work piece having an edge formed thereon and providing a guiding instrument. The guiding instrument has a base member, guide member, and linking member. The base member has an aligning wall and a platform extending outwardly from the aligning wall. The guide member is pivotally coupled to the base member. The elongated linking member extends between the base member and the guide member. A first end of the elongated linking member is slidingly coupled to the base member and a second end of the elongated linking member is releasably coupled to at least one of the base member and the guide member. The method additionally includes the steps of positioning the guide member at an angle with respect to the base member, placing the guiding instrument on the surface of the work piece, aligning the aligning wall of the base member along the edge of the work piece, and guiding a cutting tool along a surface of the guide member to form a cut in the work piece.

Further areas of applicability will become apparent from the description provided herein. It should be understood that the description and specific examples are intended for purposes of illustration only and are not intended to limit the scope of the present disclosure.

### DRAWINGS AND ADDITIONAL MATERIALS

The drawings described herein are for illustration purposes only and are not intended to limit the scope of the present disclosure in any way.

FIG. 1 is a left side perspective view of the guiding apparatus according to an embodiment of the invention, showing the apparatus in a first arrangement;

FIG. 2 is a top plan view of the guiding apparatus of FIG. 1;

FIG. 3A is a top plan view of the guiding apparatus of FIG. 1, showing the guiding apparatus in a second arrangement;

FIG. 3B is a top plan view of the guiding apparatus of FIG. 1, showing the guiding apparatus in a third arrangement;

FIG. 4A is a top plan view of the guiding apparatus of FIG. 1, showing the guiding apparatus in a consolidated arrangement;

FIG. 4B is a front elevational view of the guiding apparatus of FIG. 4A;

FIG. 5 is a top plan view of a guiding apparatus according to n alternate embodiment of the invention;

FIG. 6A is a top plan view of the guiding apparatus of FIG. 5, showing the guiding apparatus in a consolidated arrangement;

FIG. 6B is a front elevational view of the guiding apparatus of FIG. 6A;

FIG. 7 is front perspective view of the guiding apparatus of FIG. 1, showing an exemplary application according to an embodiment of the invention; and

FIG. 8 is a front plan view of a guiding apparatus according to an alternate embodiment of the invention, showing the guiding apparatus in a left hand arrangement.

### DETAILED DESCRIPTION OF THE INVENTION

The following description is merely exemplary in nature and is not intended to limit the present disclosure, application, or uses.

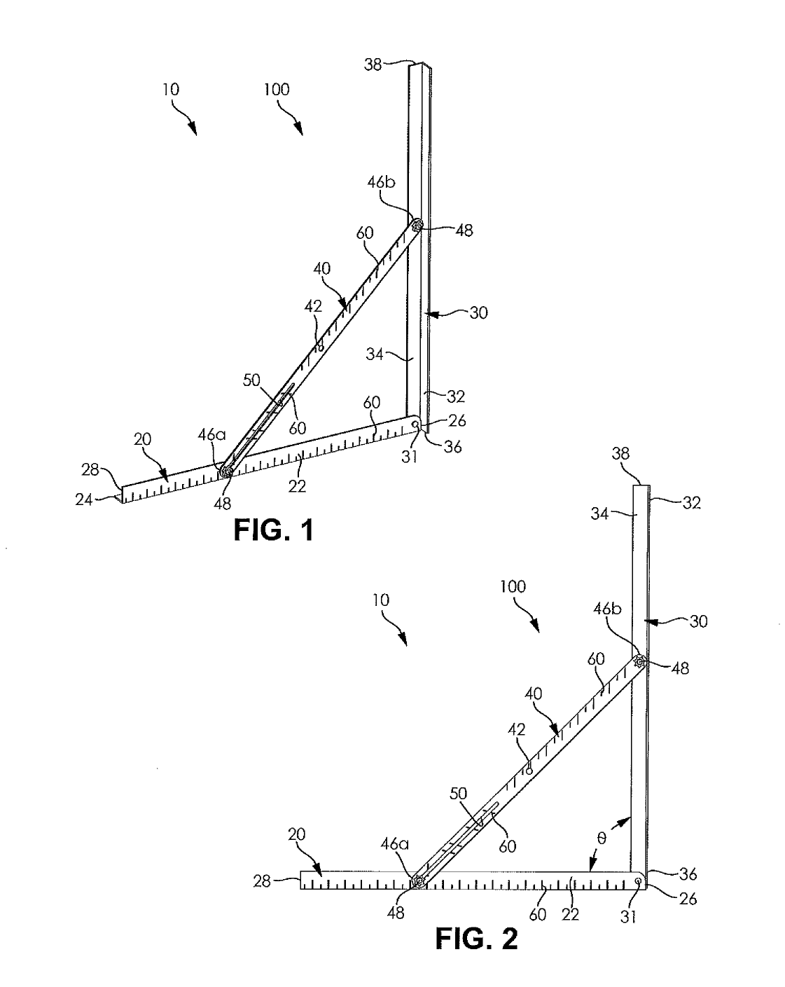

Referring to FIGS. 1-5, there is illustrated a guiding instrument 10 for use in forming cuts in a work piece 12 with a cutting tool 16 according to an embodiment of the invention. The guiding instrument 10 includes an elongated base member 20, an elongated guide member 30, and an elongated linking member 40.

The base member 20 includes a substantially planar platform 22 and a substantially planar aligning wall 24. The aligning wall 24 extends outwardly and substantially perpendicularly from the platform 22 forming an L-shaped cross-section of the base member 20. It is understood, that the base member 20 can have any cross-sectional shape as desired to facilitate precise measurements and accurate cutting of the work piece 12.

The guide member 30 has a substantially planar guide wall 32 configured to guide the cutting tool 16 along an outer surface thereof. A substantially planar platform 34 extends outwardly from and substantially perpendicularly from the guide wall 32 to form an L-shaped cross-section of the guide member 30. It is understood that the guide member 30 can have any cross-sectional shape as desired to facilitate guiding the cutting tool 16 to cut the work piece 12.

The guide member 30 is pivotally coupled to a first end 26 of the base member 20 so that the guide member 30 can be disposed at varying angular positions relative to the base member 20. As illustrated in the embodiments shown in FIGS. 1-4B, a first end 36 of the guide member 30 is pivotally coupled to the first end 26 of the base member 20. However, it is understood that the guide member 30 can be pivotally coupled to the base member 20 at any distance from the first end 36 of the guide member 30 as desired. A fastener 31 can be used to couple the guide member 30 to the base member 20 such as a pivoting bolt, a hinge, a pin, an adjustment device, or any other coupling means configured to allow pivoting as desired. Additionally, epoxy can be employed to facilitate smoothly securing the fastener 31 in position for coupling. In certain embodiments, the platform 34 of the guide member 30 and the platform 22 of the base member 20 are coupled to each other so that an inner surface of the base member 20 is at least in partial contact with and supported by an inner surface of the guide member 30.

The elongated linking member 40 is disposed on the guiding instrument 10 and extends between the base member 20 and the guide member 30. The linking member 40 as shown is substantially planar and configured to facilitate angularly positioning the guide member 30 relative to the base member 20. However, the linking member 40 can have an L-shaped cross-section, a U-shaped or channel cross section, a rectangular cross-section, a triangular cross-section, or any other cross-sectional shape to facilitate precise measurements and accurate cutting of the work piece 12, as desired. A first end 46a and a second end 46b of the linking member 40 have arcuate edges to form an elongated oval shape of the linking member 40. However, the linking member 40 can have any shape as desired such as substantially rectangular, for example.

The second end 46b of the linking member 40 is releasably and pivotally coupled to the guide member 30 intermediate the first end 36 of the guide member 30 and a second end 38 of the guide member 30. The first end 46a of the linking member 40 is releasably and slidingly coupled to the base member 20 intermediate the first end 26 of the base member 20 and a second end 28 of the base member 20. The linking member 40 is coupled to the guide member 30 and the base member 20 wherein a portion of the guide member 30, a portion of the base member 20, and the linking member 40 form a generally triangular shape. The linking member 40 is coupled to each of the base member 20 and the guide member 30 by adjustment devices 48. The adjustment devices 48 can be an adjustable thumb knob, for example. However, any coupling means can be used as desired such as a pivoting bolt, a hinge, a pin, or any other coupling means configured to allow pivoting, for example. Additionally, epoxy can be employed to facilitate smoothly securing the fastener 31 in position for coupling.

FIGS. 1-2 illustrate the guide member 30 positioned at an angle θ with respect to the base member 20. In FIGS. 1-2, the guiding instrument 10 is positioned in a 0 degree arrangement 100. The 0 degree arrangement 100 of the guiding instrument 10 is configured wherein the guide member 30 is positioned substantially perpendicular to the base member 20 so that the angle θ is about 90 degrees. The 0 degree arrangement 100 facilitates guiding the cutting tool 16 to form a cut in the work piece 12 that is substantially perpendicular to an edge 54 of the work piece 12.

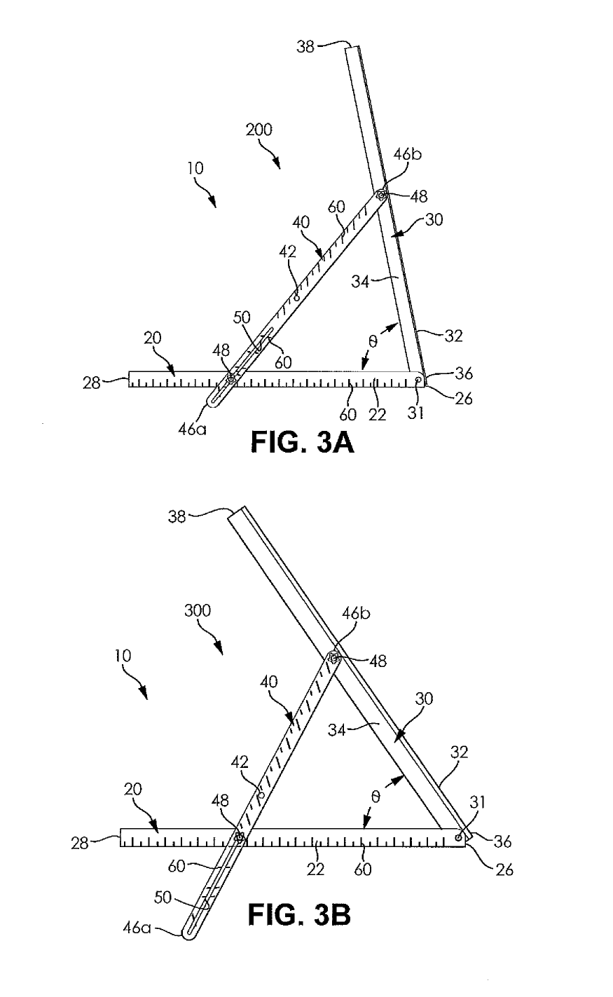

As shown in FIGS. 3A-3B the guide member 30 can be positioned at other angles θ relative to the base member 20. In a non-limiting example, as shown in FIG. 3A, the guiding instrument 10 is positioned in a 15 degree arrangement 200 in which the angle θ is about 75 degrees. The 15 degree arrangement 200 is configured to facilitate guiding the cutting tool 16 to form a cut in the work piece 12 at 15 degrees from a line perpendicular to the edge 54 of the work piece 12. In another non-limiting example, as shown in FIG. 3B, the guiding instrument 10 is positioned in a 30 degree arrangement 300 in which the angle θ is about 60 degrees. The 30 degree arrangement 300 is configured to facilitate guiding the cutting tool 16 to form a cut in the work piece 12 at 30 degrees from a line perpendicular to the edge 54 of the work piece 12. However, it is understood that the guiding instrument 10 can be positioned in any arrangement so that the guide member 30 is positioned at any angle θ with respect to the base member 20. For example, the guiding instrument 10 can be positioned in an 11.25 degree arrangement where the angle θ is about 78.75 degree, in a 22.5 degree arrangement where the angle θ is about 67.5, a 45 degree arrangement where the angle θ is about 45 degrees, or any other arrangement where the angle θ is any angle as desired.

As shown in FIGS. 1-3B, the linking member 40 includes a slot 50 formed therein to facilitate a sliding relationship between the linking member 40 and the base member 20. The adjustment device 48 coupling the linking member 40 to the base member 20 is received through the slot 50. The adjustment device 48 can be loosened to selectively permit the linking member 40 to slide with respect to the base member 20 to various positions. Alternatively, the adjustment device 48 can be tightened to maintain the linking member 40 in one of the various positions. Each of the various positions of the linking member 40 corresponds to one of the angular arrangements (the 0 degree arrangement 100, the 15 degree arrangement 200, the 30 degree arrangement 300) of the guiding instrument 10. For example in FIG. 3A, the adjustment device 48 is received in a portion of the slot 50 to position the linking member 40 in a position corresponding to the 15 degree arrangement. In FIG. 3B, for example, the adjustment device 48 is received in a portion of the slot 50 to position the linking member 40 in a position corresponding to the 30 degree arrangement.

The linking member 40 can further include an aperture 42 formed therein. The adjustment device 48 coupling the linking member 40 to the base member 20 can be received through the aperture 42 to maintain an angular arrangement. For example, the aperture 42 can be formed in the linking member 40 to correspond to the 45 degree arrangement, wherein the guide member 30 is positioned at a 45 degree with respect to the base member 20 when the adjustment device is received through the aperture 42 to couple the guide member 30 to the base member 20. It is understood any number of slots or apertures can be used to facilitate positioning the guide member 30 at any angle with respect to the base member 20.

In certain embodiments, the guiding instrument 10 includes indicia 60 disposed thereon. The outer surface of the base member 20 can include the indicia 60 disposed on the platform 22 thereof. The indicia 60 disposed on the platform 22 can correspond to a measurement system to facilitate precise measurements when moving the guiding instrument 10 along the work piece 12 to form multiple cuts. In a non-limiting example, the indicia 60 of measurement system can compensate for a width w of a portion of the cutting tool 16 from an edge to the knife thereof. The measurement system can then begin at a number corresponding to the width w of the portion of the cutting tool 16.

Additionally, a surface of the linking member 40 can also include the indicia 60 disposed thereon. The indicia 60 disposed on the linking member 40 can correspond to the indicia 60 disposed on the platform 22 of the base member 20. For example, the indicia 60 of the base member 20 can align with the indicia 60 of the linking member 40 when the guiding instrument 10 is in the 0 degree arrangement 100. The indicia 60 disposed on the linking member 40 can also include measurements corresponding to the angular arrangements (the 0 degree arrangement 100, the 15 degree arrangement 200, the 30 degree arrangement 300) of the guiding instrument 10. The indicia 60 corresponding to the angular measurements can be disposed on the surface of the linking member 40 adjacent portions of the slot 50 to indicate where to properly position the linking member 40 for each angular arrangement (the 0 degree arrangement 100, the 15 degree arrangement 200, the 30 degree arrangement 300).

An anti-slip layer (not shown) can be formed on a surface of the guide member 30. For example, an anti-slip layer can be formed on an outer surface of the platform 34 of the guide member 30 to militate against movement of the guiding instrument 10 with respect to the work piece 12. The anti-slip layer can be applied to or coupled to the surface of the guide member 30. The anti-slip layer can be a non-slip paint, a non-slip tape, a non-slip coating, a surface roughening or embossment to the surface of the guide member 30 or any other anti-slip component, as desired. The anti-slip layer can also be formed on any other portion of the guiding instrument 10, as desired, such as a surface of the base member 20 or a surface of the linking member 40.

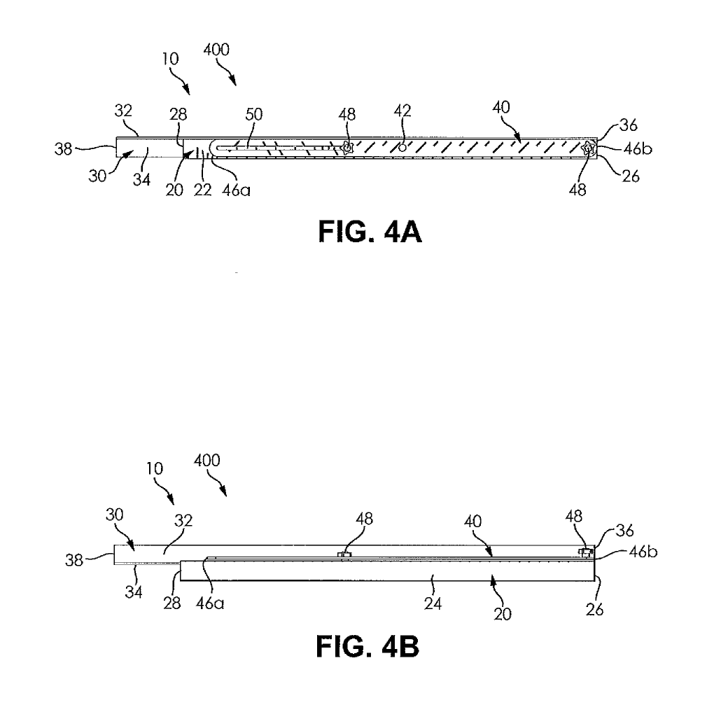

In FIGS. 4A and 4B, the guiding instrument 10 is illustrated in a linear, consolidated arrangement 400. In the consolidated arrangement 400, the linking member 40 and the guide member 30 are aligned with the base member 20 along a length thereof to facilitate portability and storage. The platform 34 of the guide member 30 is disposed beneath of and supports the platform 22 of the base member 20 so that the inner surface of the guide member 30 contacts the inner surface of the base member 20. The platform 22 of the base member 20 is disposed beneath and supports the linking member 40 so that an outer surface of the base member 20 contacts the surface of the linking member 40.

To arrange the guiding instrument 10 in the consolidated arrangement 400, the second end 46b of the linking member 40 can be decoupled from the guide member 30 by loosening the adjustment device 48. The adjustment device 48 coupling the first end 46a of the linking member 40 to the base member 20 can be loosened to permit the linking member 40 to slide with respect to the base member 20. The adjustment device 48 is positioned at an end of the slot 50 extending away from the first end 46a of the linking member 40. The linking member 40 is permitted to pivot about the adjustment device 48, coupling the first end 46a of the linking member 40 to the base member 20. The linking member 40 pivots until substantially aligned with the length of the base member 20. Additionally, the guide member 30 pivots about the fastener 31, coupling the base member 20 and the guide member 30. The guide member 30 pivots to align with the length of the base member 20. In the consolidated arrangement, the base member 20, the guide member 30, and the linking member 40 are positioned parallel with respect to each other.

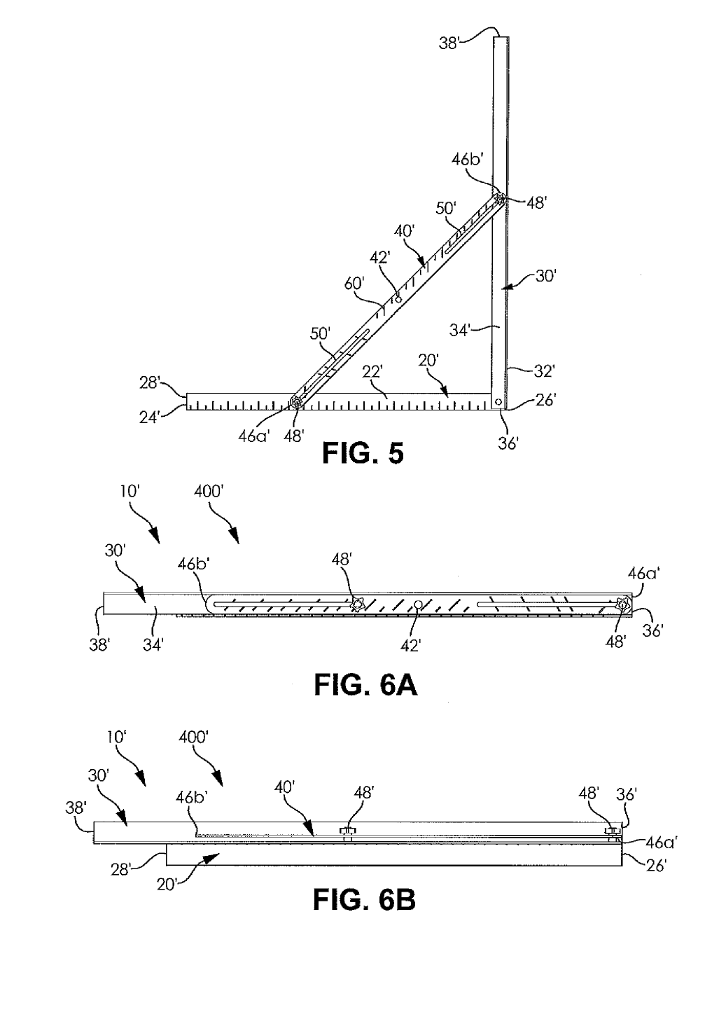

FIG. 5 illustrates a guiding instrument 10′ according to another embodiment of the disclosure. Similar reference numerals are used to describe features substantially similar to those described in FIGS. 1-4B, except with a prime (′) symbol placed after such reference numerals. The guiding instrument 10′ is substantially similar to the guiding instrument 10 described hereinabove and illustrated in FIGS. 1-4B except that the base member 20′ is positioned beneath the guide member 30′. The platform 34′ of the guide member 30′ and the platform 22′ of the base member 20′ are coupled to each other so that an outer surface of the guide member 30′ is at least in partial contact with and supported by an outer surface of the base member 20′. This arrangement of the guiding instrument 10′ facilitates guiding certain tools having portions configured to extend beneath the guide member 30′ in application.

The guiding instrument 10′ also includes two slots 50′ formed adjacent the first end 46a′ and the second end 46b′ of the linking member 40′. The slot 50′ formed adjacent the first end 46a′ is substantially similar to the slot 50 shown and described in FIGS. 1-4B. The slot 50′ formed adjacent the second end 46b′ facilitates a sliding relationship between the linking member 40′ and the guide member 30′. The adjustment device 48′ coupling the linking member 40′ to the guide member 30′ is received through the slot 50′ adjacent the second end 46b′ of the linking member 40′. The adjustment device 48′ coupling the linking member 40′ to the guide member 30′ can be loosened to selectively permit the linking member 40′ to slide with respect to the guide member 30′.

To arrange the guiding instrument 10′ in the consolidated arrangement 400′, the first end 46a′ of the linking member 40′ can be decoupled from the base member 20′ by loosening the adjustment device 48′. The adjustment device 48′ coupling the second end 46b′ of the linking member 40′ to the guide member 30′ can be loosened to permit the linking member 40′ to slide with respect to the guide member 30′. The adjustment device 48′ is positioned at an end of the slot 50′ adjacent the second end 46b of the linking member 40′. The linking member 40′ is permitted to pivot about the adjustment device 48′ coupling the second end 46b′ of the linking member 40′ to the guide member 30′. The linking member 40′ pivots until substantially aligned with the length of the guide member 30′. Additionally, the base member 20′ pivots about the fastener 31′, coupling the base member 20′ and the guide member 30′. The base member 20′ pivots to align with the length of the guide member 30′. The adjustment device 48′ for coupling the first end 46a′ of the linking member 40′ to the base member 20′ can then be used to couple the first end 46a′ of the linking member 40′ to the first end 36′ of the guide member 30′ to maintain the linking member 40′ in alignment with the guide member 30′. In the consolidated arrangement, the base member 20′, the guide member 30′, and the linking member 40′ are positioned parallel with respect to each other.

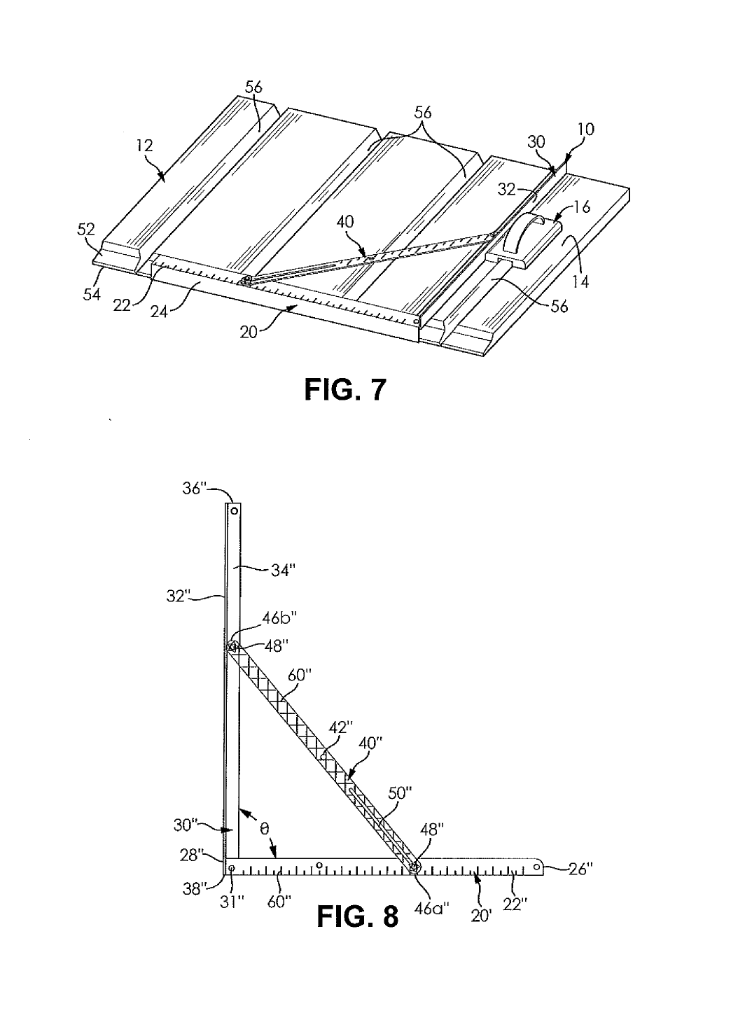

FIG. 7 illustrates the guiding instrument 10 arranged in the 0 degree arrangement 100 utilized in an exemplary application according to an embodiment of the invention. The guiding instrument 10 described in FIGS. 1-4B is illustrated. However, the guiding instrument 10′ according to FIGS. 5-6B can be employed in a substantially similar manner and include substantially similar dimensions as described hereinafter. In the illustrated embodiment, the work piece 12 is a fiberglass duct board panel used to form ducts for heating, ventilation, and air conditioning. The work piece 12 is pre-formed with a female ship lap 52 at one end thereof and a male ship lap (not shown) at an opposing end thereof. The female ship lap 52 extends inwardly from the edge 54 of the work piece 12. It is understood, the work piece 12 can be any type of panel or material, with or without ship lapped edges, used for ductwork, carpentry, or any other architecture, engineering, and construction applications, for example. The cutting tool 16 is a sled tool including a V shaped cutting knife to form V shaped grooves 56 in the work piece 12. The V shaped grooves 56 facilitate folding the work piece 12 into a section of duct. The cutting tool 16 can be any cutting tool as desired such as a ship lap tool, duct knife, or any other type of cutting tool, for example.

In application, the base member 20 is aligned with an edge 54 of the female ship lap 52 so that the aligning wall 24 is in contact with the edge 54 of the female ship lap 52. The platform 22 of the base member 20 extends over the female ship lap 52 and aligns with the surface 14 of the work piece 12. The alignment of the platform 22 of the base member 20 with the surface 14 of the work piece 12 facilitates precise measurement and accurate cutting. The guide member 30 extends perpendicular to the edge 54 of the work piece 12. in the embodiment illustrated, the platform 34 of guide member 30 rests on the surface 14 of the work piece 12. However, where the guiding instrument 10′ of FIGS. 5-6B is utilized, the space can be formed between the work piece 12 and the guide member 30′. The anti-slip layer can militate against the guiding instrument 10 moving with respect to the work piece 12.

The cutting tool 16 can then be guided along the guide wall 32 of the guide member 30 by a user. The cut begins at the edge 54 of the work piece 12, through the female ship lap 52, and extends towards an opposing edge of the work piece 12 to create the V shaped groove 56. Force can be applied to the linking member 40 by a hand of the user, for example, to anchor and stabilize the guiding instrument 10 forming the cut in the work piece 12. The linking member 40 facilitates stability of the guiding instrument 10 and militates against undesired pivoting of the guiding instrument 10 during cutting of the work piece 12. Advantageously, the configuration of the base member 20, the guide member 30, and the linking member 40 permits the guiding instrument 10 to be utilized to obtain precise measurements and accurate cutting with a work piece 12 having ship lapped edges. Accuracy can be obtained by aligning indicia 60 disposed on the guiding instrument 10 with existing grooves or other marks on the work piece 12. The indicia 60 disposed on the base member 20 can be aligned with the indicia 60 disposed on the linking member 40 to obtain accuracy and precise measurements.

In certain embodiments, the height of the aligning wall 24 of the base member 20 corresponds to a thickness of the work piece 12. For example, the height of the aligning wall 24 can be 1″, 1.5″, or 2″. A width of the platform 22 of the base member 20 can be any width as desired to extend from the edge 54, of the work piece 12 over the female ship lap 52. In a non-limiting example, the width of the platform 22 is equal to or greater than the width of the female ship lap 52 such as 2″. The length of the guide member 30 is any length as desired to span from the edge 54 of the work piece 12 to the opposing edge of the work piece 12. The width of the platform 34 of the guide member 30 has any width as desired to facilitate consolidating the guiding instrument 10 into a consolidated arrangement 400 and supporting the base member 20 and/or the linking member 40. It is understood that any dimensions can be used for the base member 20, the guide member 30, and the linking member 40, as desired.

FIG. 8 illustrates a guiding instrument 10″ according to another embodiment of the invention. Similar reference numerals are used to describe features substantially similar to those described in FIGS. 1-7, except with a double prime (″) symbol placed after such reference numerals. The guiding instrument 10″ is substantially similar to the guiding instruments 10, 10′ described hereinabove and illustrated in FIGS. 1-7 except that the guiding instrument 10″ is interchangeable for both a right hand and a left hand configuration. The guiding instrument 10″ can be adapted from the right hand arrangement (as described hereinabove and illustrated in FIGS. 1-5) into the left hand arrangement as shown in the illustrated embodiment. The right hand arrangement facilitates forming a cut in the work piece 12 by a right handed user and the left hand arrangement facilitates forming a cut in the work piece 12 by a left handed user.

In order to arrange the guiding instrument 10″ from the right hand arrangement to a guiding instrument 10″ in the left hand arrangement, the first end 36″ of the guide member 30″ can be decoupled from the first end 26″ of the base member 20″. The second end 38″ of the guide member 30″ is then pivotally and releasably coupled to the platform 22″ of the base member 20″ at a second end 28″ thereof. The linking member 40″ is pivoted about the adjustment device 48″ coupling the linking member 40″ to the base member 20″. The second end 46b″ of the linking member 40″ is coupled to the guide member 30″ by the adjustment device 48″ to form the left hand arrangement.

It is understood that the left hand arrangement can be formed by other configurations of the base member 20″, the guide member 30″, and the linking member 40″, as desired. For example, the platform 34″ of the guide member 30″ and the aligning wall 24″ of the base member 20″ can be coupled to each other so that the aligning wall 24″ extends over the ship lap 52 of the work piece 12 instead of the platform 22″ of the base member 20″. In this example, the aligning wall 24″ can have the indicia 60″ disposed thereon corresponding to the left hand arrangement and the platform 22″ can have the indicia 60′ disposed thereon corresponding to the right hand arrangement. The linking member 40″ can include the indicia 60″ corresponding to the right hand arrangement and the left hand arrangement, which can be latticed.

While certain representative embodiments and details have been shown for purposes of illustrating the invention, it will be apparent to those skilled in the art that various changes may be made without departing from the scope of the disclosure, which is further described in the following appended claims.

What is claimed is:

1. A guiding instrument for forming a cut in a work piece with a cutting tool, the guiding instrument comprising:
a base member having an aligning wall and a platform, the aligning wall configured for alignment with an edge of the work piece, and the platform extending outwardly from the aligning wall;
a guide member pivotally coupled to the base member; and
an elongated linking member extending between the base member and the guide member, a first end of the elongated linking member coupled to the base member and a second end of the elongated linking member releasably coupled to at least one of the base member and the guide member.

2. The guiding instrument of claim 1, wherein the platform of the base member extends substantially perpendicularly from the aligning wall.

3. The guiding instrument of claim 1, wherein the base member has an L-shaped cross section.

4. The guiding instrument of claim 1, wherein the guide member includes a platform and a guide wall extends outwardly from the platform.

5. The guiding instrument of claim 4, wherein the platform of the guide member is coupled to the platform of the base member.

6. The guiding instrument of claim 5, wherein one of an inner surface of the base member contacts an inner surface of the guide member and an outer surface of the base member contacts an outer surface of the guide member.

7. The guiding instrument of claim 1, wherein the elongated linking member is slidingly coupled to the base member.

8. The guiding instrument of claim 7, wherein the first end of the elongated linking member is releasably coupled to the guide member intermediate a first end of the guide member and a second end of the guide member, and the second end of elongated linking member is slidingly coupled to the base member intermediate a first end of the base member and a second end of the base member.

9. The guiding instrument of claim 1, wherein the elongated linking member includes a slot formed therein, the slot configured to facilitate pivoting of the guide member with respect to the base member.

10. The guiding instrument of claim 9, wherein an adjustment device couples the first end of the elongated linking member to the base member, the adjustment device received through the slot of the elongated linking member.

11. The guiding instrument of claim 1, wherein the guide member is selectively positionable at an angle with respect to the base member, wherein the angle is in a range of about 0 degrees to about 90 degrees.

12. The guiding instrument of claim 1, wherein the base member, the guide member, and the elongated linking member cooperate to form a linear consolidated arrangement of the guiding instrument.

13. The guiding instrument of claim 1, further comprising indicia formed on a surface of at least one of the base member, the guide member, and the elongated linking member.

14. The guiding instrument of claim 1, further comprising an anti-slip layer formed on at least a portion of at least one of the base member, the guide member, and the linking member.

15. A guiding instrument for forming a cut in a work piece with a cutting tool, the guiding instrument comprising:
a base member having an aligning wall and a platform, the aligning wall configured for alignment with an edge of the work piece, and the platform extending outwardly from the aligning wall;
a guide member pivotally coupled to the base member; and
an elongated linking member extending between the base member and the guide member, a first end of the elongated linking member coupled to the base member and a second end of the elongated linking member releasably coupled to at least one of the base member and the guide member, wherein the base member, the guide member, and the elongated linking member cooperate to selectively form at least a first arrangement, a second arrangement, and a third arrangement.

16. The guiding instrument of claim 15, wherein the guide member is positioned perpendicular to the base member in the first arrangement, the guide member is positioned at an angle with respect to the base member in the second arrangement, and the guide member is positioned parallel with respect to the base member in the third arrangement.

17. A method of forming a cut in a work piece, comprising the steps of:
providing a work piece having an edge formed thereon;
providing a guiding instrument, the guiding instrument having a base member having an aligning wall and a platform extending outwardly from the aligning wall, a guide member pivotally coupled to the base member, and an elongated linking member extending between the base member and the guide member, a first end of the elongated linking member slidingly coupled to the base member and a second end of the elongated linking member releasably coupled to at least one of the base member and the guide member;
positioning the guide member at an angle with respect to the base member;
placing the guiding instrument on the surface of the work piece;
aligning the aligning wall of the base member along the edge of the work piece; and
guiding a cutting tool along a surface of the guide member to form a cut in the work piece.

18. The method of claim 17, wherein the platform of the base member extends at least partially over a portion of the surface of the work piece.

19. The method of claim 17, wherein the work piece includes a female ship lap formed along the edge thereof, the platform of the base member extending over the female ship lap.

20. The method of claim 17, further comprising the step of applying force to the elongated linking member to militate against movement of the guiding instrument with respect to the work piece.
